(19) United States
(12) Patent Application Publication
(10) Pub. No.: US 2019/0074973 A1
(43) Pub. Date: Mar. 7, 2019

(54) Method of generating an authentication message, method of authenticating, authentication device and authentication base device

(71) Applicant: FRAUNHOFER-GESELLSCHAFT ZUR FÖRDERUNG DER ANGEWANDTEN FORSCHUNG, München (DE)

(72) Inventors: Niels HADASCHIK, München (DE); Marco Breiling, Erlangen (DE); Tobias DRÄGER, Baiersdorf (DE)

(21) Appl. No.: 16/084,649

(22) PCT Filed: Jan. 31, 2017
(86) PCT No.: PCT/EP2017/052056

§ 371 Date: Sep. 13, 2018

(30) Foreign Application Priority Data
Mar. 15, 2016 (DE) 10 2016 104 771.6

(51) Int. Cl. H04L 9/32; H04L 29/06; H04L 9/14; B60R 25/24

(52) U.S. Cl. CPC H04L 9/3234; H04L 63/0478; B60R 2325/108; B60R 25/24; H04L 2209/84; H04L 9/14

(57) ABSTRACT

A method of generating an authentication message includes receiving an initialization message; encrypting the initialization message by means of a first cryptographic method to obtain an intermediary message; and encrypting the intermediary message by means of a second cryptographic method to obtain the authentication message.

### TECHNICAL FIELD

Embodiments relate to a method of generating an authentication message and methods of authenticating which are used, for example, to check whether a user of an authentication device is authorized to use an item or a service.

### BACKGROUND

The so-called cryptographic location serves for the spatially limited authentication of a person or an object. This may be done by means of a mobile radio transceiver or an authentication device mounted to the person and/or the object which responds to a radio request of (firmly) installed radio technology and/or from an authentication base device or initiates a radio request itself using this radio infrastructure. For authentication the authentication device encrypts a message which it then transfers to the authentication base device. In the more special case of cryptographic distance measurement an additional limitation of the spatial communication range is installed. The encryption may see to the privacy of the authenticated and also the not authenticated user. Further, the encryption may effectively restrict the access rights or the rights of use of an item or service against potential attackers. Such systems are used, for example, in car keys to open the doors of the vehicle only for an authorized user having a corresponding authentication device or also to start the vehicle engine. One possibility to attack such systems is the so-called relay attack wherein the attacker each amplifies and transfers the signals between infrastructure and mobile transceiver. By distance limitation one may try to exclude such an attacker. In this respect, so-called “time of flight” measurements may be used (also called two way ranging and/or round trip time) which evaluate the signal runtimes between the authentication base device and the authentication device.

A further possibility of an attack is to crack the encryption of the authentication device and thus be able to answer a radio request of the authentication base device and/or an initialization message contained therein instead of the authentication device and thus simulate an authorization to use the secured infrastructure. Such an attack would only be conditionally preventable by “time of flight” measurements. In particular if due to limited hardware or current supply, like e.g. in the already mentioned car keys, the length of the used key sequences is limited such attacks may be realizable.

There is thus a demand to improve existing methods of authentication.

### SUMMARY

This object is solved by the embodiments of the independent claims. The dependent claims relate to further advantageous embodiments.

Embodiments of a method of generating an authentication message include receiving a transmitted initialization message and encrypting the transmitted initialization message by means of a cryptographic method in order to generate an intermediary message. This intermediary message is encrypted by a second cryptographic method to receive the authentication message which is used to check in an authentication base device which generated the transmitted initialization message whether the authentication message is regarded as being authenticating and thus a transmitter of the authentication message is regarded as being authorized. As compared to conventional methods which execute one single encryption of a transmitted initialization message to receive the authentication message, by encrypting twice using different cryptographic methods intercepting the communication and spying out the encryption algorithm used for generating the authentication message and the used encryption sequence is made significantly more difficult or even impossible.

Embodiments of a method of authenticating include transmitting an initialization message which is, for example, processed by an authentication device, to generate an authentication message. This authentication message is received and the authentication message is decrypted by means of the same second cryptographic method used when generating the same in order to obtain a received intermediary message. Decrypting the received intermediary message by means of a first cryptographic method generates a received initialization message. The received initialization message and the transmitted initialization message are compared to determine whether the authentication message is regarded as being authenticating. Just like when generating the authentication message, when evaluating the authentication message the two used cryptographic methods are applied successively to guarantee the high security of the method.

Embodiments of an authentication device include a receiver configured to receive an initialization message and a first encryption module configured to encrypt the received initialization message by means of a first cryptographic method in order to obtain an intermediary message. A second encryption module is configured to encrypt the intermediary message by means of a second cryptographic method to obtain the authentication message. A transmitter serves for transmitting the authentication message.

One embodiment of an authentication base device for a communication with the authentication device includes a transmitter configured to transmit an initialization message and a receiver configured to receive an authentication message. A first decryption module is configured to decrypt the authentication message by a second cryptographic method to obtain a received intermediary message. A second decryption module is configured to decrypt the received intermediary message by means of a first cryptographic method to obtain a received initialization message. A decision module configured to compare the received initialization message and the transmitted initialization message to determine whether the authentication device is considered as being authenticated.

### BRIEF DESCRIPTION OF THE FIGURES

Embodiments are explained in more detail with reference to the accompanying Figures, in which:

FIG. 1 illustrates a flowchart of an embodiment of a method of generating an authentication message;

FIG. 2 illustrates a flow chart of an embodiment of a method of authenticating;

FIG. 3 illustrates a block diagram of an embodiment of an authentication device for being used with analog signal forms;

FIG. 4 illustrates a block diagram of a further embodiment of an authentication device for being used with analog signal forms;

FIG. 5 illustrates a block diagram of an embodiment of an authentication device for being used with digital signals;

FIG. 6 illustrates a block diagram of a further embodiment of an authentication device for being used with digital signals;

FIG. 7 is a block diagram of an embodiment of an authentication base device; and

FIG. 8 illustrates an implementation of an embodiment for opening an automobile.

### DESCRIPTION

Various embodiments will now be described with reference to the accompanying drawings in which some example embodiments are illustrated. In the Figures, the thicknesses of lines, layers and/or regions may be exaggerated for clarity.

Like numbers refer to like or similar components throughout the following description of the included figures map, which merely show some exemplary embodiments. Moreover, summarizing reference signs will be used for components and objects which occur several times in one embodiment or in one Figure but are described at the same time with respect to one or several features. Components and objects described with like or summarizing reference signs may be implemented alike or also differently, if applicable, with respect to one or more or all the features, e.g. their dimensioning, unless explicitly or implicitly stated otherwise in the description.

Although embodiments may be modified and changed in different ways, embodiments are illustrated as examples in the Figures and are described herein in detail. It is to be noted, however, that it is not intended to restrict embodiments to the respectively disclosed forms but that embodiments rather ought to c any functional and/or structural modifications, equivalents and alternatives which are within the scope of the invention. Same reference numerals designate same or similar elements throughout the complete description of the figures.

It is noted, that an element which is referred to a being “connected” or “coupled” to another element, may be directly connected or coupled to the other element or that intervening elements may be present. If an element is referred to as being “directly connected” or “directly coupled” to another element, no intervening elements are be present. Other terms used to describe a relationship between elements ought to be interpreted likewise (e.g. “between” versus “directly between”, “adjacent” versus “directly adjacent”, etc.).

The terminology used herein only serves for the description of specific embodiments and should not limit the embodiments. As used herein, the singular form such as “a,” “an” and “the” also include the plural forms, as long as the context does not indicate otherwise. It will be further understood that the terms e.g. “comprises,” “comprising,” “includes” and/or “including,” as used herein, specify the presence of the stated features, integers, steps, operations, elements and/or components, but do not preclude the presence or addition of one and/or more other features, integers, steps, operations, elements, components and/or any group thereof.

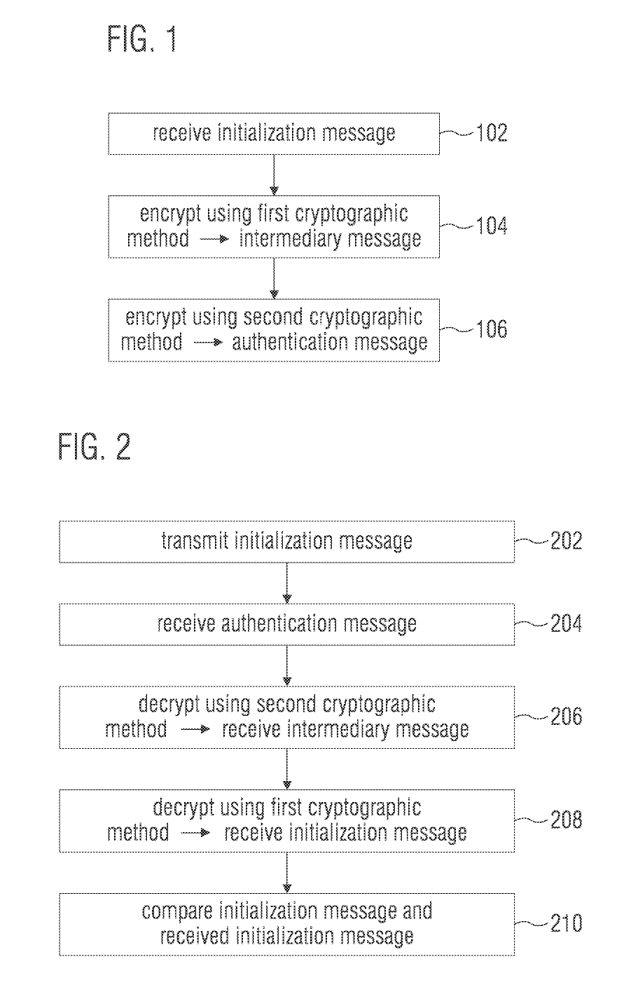

FIG. 1 illustrates a flow chart of an embodiment of a method of generating an authentication message using which the authorization for using an infrastructure and/or a service may be proven to an authentication base device. An infrastructure may here include any devices secured against unauthorized use by the authentication base device, like, for example, automobiles, construction machines, tools or the like. A service may, for example, be a service of a third party which is for free or with costs or may also include the authentication with a computer system or a special software.

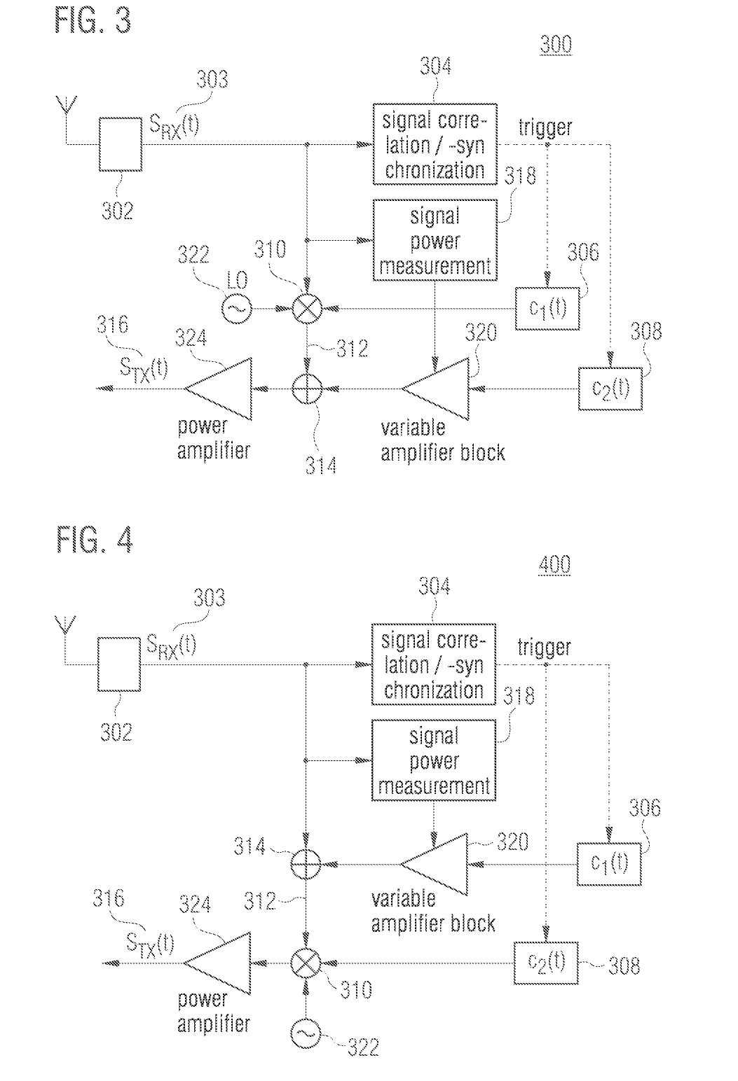

The method of generating an authentication message includes receiving a transmitted initialization message 102. Encrypting the received initialization message 104 by means of a first cryptographic method generates an intermediary message. This intermediary message is encrypted by a second cryptographic method to obtain the authentication message which is used to check whether the authentication message is regarded as authenticating and thus a transmitter of the authentication message is regarded as being authorized in an authentication base device which generated the transmitted initialization message 104. As compared to conventional methods which execute one single encryption of an initialization message to receive the authentication message, by encrypting twice using different cryptographic methods intercepting the communication and spying out the encryption algorithm used for generating the authentication message and the used encryption sequence is made significantly more difficult or even impossible. When using short key sequences which are frequently used due to limitations of hardware, for example in car keys, this may significantly increase security, in particular when different cryptographic methods are used. A cryptographic method here is in particular defined by the algorithm used to encrypt the transmitted initialization message by means of the key sequence. Depending on whether the encryption is digital or analogue, the same may be implemented by a different calculation rule or by different hardware components which combine the transmitted initialization message and the key sequence. Examples for analog and for digital implementations are illustrated in FIGS. 3 to 6. In these implementations, as used cryptographic methods, adding the key sequence to the encrypted message and multiplying the key sequence with the message to be encrypted are combined, as is explained with reference to the Figures.

FIG. 2 illustrates a flow chart of an embodiment of a method of authenticating, including transmitting an initialization message 202 which is, for example, processed by an authentication device, to generate an authentication message. The authentication message is received in method act 204. In method act 206 this authentication message is received and the authentication message is decrypted by means of the same second cryptographic method used when generating the same in order to obtain a received intermediary message. In act 208 decrypting the received intermediary message by means of a first cryptographic method is performed to obtain a received initialization message. In act 210 the received initialization message and the transmitted initialization message are compared (the original, originally generated and additionally provided initialization message) to determine whether the authentication message is regarded as being authenticating.

Just like when generating the authentication message, when evaluating the authentication message the two used cryptographic methods are applied successively to guarantee the high security of the method.

According to some embodiments, the authentication is regarded as being successful when the received initialization message and the transmitted initialization message correspond to each other, which is in particular the case when both messages deviate from each other by less than an admissible number of bits according to some embodiments. This correspondence or match may in some further embodiments be evaluated by any other randomly settable threshold value.

Depending on the type of cryptographic methods, the key sequences used in the method of authenticating and in the method of generating an authentication message may be identical if a symmetric encryption is used, or same may be corresponding public or private key sequences when an asymmetric encryption is used.

According to some embodiments of a method of authenticating further a signal runtime between transmitting the initialization message and receiving the authentication message is determined. In particular, according to some embodiments, the authentication is only evaluated as being successful when the signal runtime is less than a predetermined threshold, to be able to better detect remote relay attacks, for example.

FIG. 3 schematically illustrates an embodiment of an authentication device 300. In the embodiments described in FIGS. 3 and 4 the used cryptographic methods are implemented analogously, an analog-to-digital conversion of the received initialization message may be omitted. A still possible digital generation of the key sequences c1(t) and c2(t) including a digital to analog conversion and digital signal detection, synchronization and power estimation are external to the direct signal chain implementing the two cryptographic methods.

By means of a receiver 302 the transmitted initialization message 303 is received. In a signal analyzer 304 a signal and power detection as well as the synchronization to the received signal is executed, in particular to the transmitted initialization message 303 which is further processed as an analog signal form. A signal and power detection may, for example, be based on a signal preceding the transmitted initialization message 303, for example on a signal form which serves to estimate the distance between the authentication base device and the authentication device (ranging request). The power detection may generally be based on the received power and the synchronization may also be based on a preceding preamble portion of the received signal known a priori by partial correlation. According to other embodiments, a preamble may also be omitted, when due to the preceding communication already a sufficient temporal synchronization and a sufficient power adaptation were achieved.

With the partial correlation also frame synchronization and—possibly with an interpolation a symbol synchronization may be achieved, i.e., it may be determined which time period in the received signal form corresponds to what logic information. A symbol synchronization is helpful in particular in receiver post-processing as then the modulation of authentication device and authentication base device may be overlaid in-phase. On the received preamble symbols, if necessary, also the carrier and symbol clock frequencies are adapted to those of the infrastructure transmitter (carrier and clock synchronization). For the following considerations it is assumed that a synchronization has been executed successfully and that it is thus known what time period in the received signal form corresponds to what logic information, so that key sequences may be processed synchronously with the transmitted initialization message. In the realization of the authentication device as an analog relay, in preferred implementations the transmitted initialization message and the key sequences are synchronous and the analog key sequences are generated digitally and converted into an analog signal using a digital-to-analog converter. The transmitted initialization message here is the part of the received signal which is encrypted in the method of generating an authentication message.

The first cryptographic method uses a first key sequence 306 and the second cryptographic method uses a second key sequence 308. According to some embodiments, both key sequences are of the same approximate temporal extension as the transmitted initialization message 303. According to some embodiments, a first length of the first key sequence 306 and/or a second length the second key sequence 308 deviate by less than 20% from a length of the transmitted initialization message 303. In some further embodiments, this deviation is less than 10% or less than 5%.

The key sequences 306, 308 are in some embodiments calculated after signal detection (or possibly after the preceding communication) from a key (or several keys) stored on the mobile authentication device 300. A key sequence for encrypting both sequences may, for example, be generated from three components: An own key of the authentication device 300, a key which is specific for the authentication base device and a time-dependent portion. Here, the time-dependent portion and the key of the authentication base device may be omitted in some implementations. The latter is already introduced into the received initialization message originally transmitted by the authentication base device.

In the illustrated embodiment, the first cryptographic method is based on the multiplication of the first key sequence 306 with the message to be encrypted. For this purpose, a mixer or multiplier 310 is used which multiplies the transmitted analog initialization message 303 with the first key sequence 306 which is also present as an analog signal form to obtain an intermediary message 312. The rate of the first key sequence 306 does not have to correspond to the rate of the second key sequence 308. According to some embodiments, the rate of the first key sequence 306 is smaller than the rate of the transmitted initialization message 303, however the rate is then ideally given by an integer divider.

The second cryptographic method includes adding the second key sequence 308 to the intermediary message 312. For this purpose an adder 314 is used which adds the second key sequence 308 to the intermediary message 312 to obtain the authentication message 316. The second, additive encryption stage ought to use a key sequence whose signal form corresponds to that of the multiplicatively modulated intermediary message 312 in its signal form, so that the additive portion in the authentication message 316 may not be separated and may thus be identified. This may relate both to the amplitude and also the bandwidth. According to some embodiments, a bandwidth of the first key sequence 306 and/or the second key sequence 308 deviates by less than 20% from a bandwidth of the transmitted initialization message 303 and/or the intermediary message 312. In some further embodiments, this deviation is less than 10% or less than 5%. According to further embodiments, an amplitude of the first key sequence 306 and/or the second key sequence 308 deviates by less than 20% from an amplitude of the transmitted initialization message 303 and/or the intermediary message 312.

To facilitate this, the receive power determined by the power estimator 318 is set by the variable gain block 320 so, that both additive portions, the intermediary message 312 and the second key sequence 308 (approximately) have the same power and/or amplitude, so that they may be distinguished only with difficulty or not at all in the resulting sum signal (in the example shown in FIG. 3 this is the authentication message 316). The latter results from the observability and/or the impossible conclusion to N estimates of the same type based on M<N observations.

The optional additional mixing of the signal with a local oscillation frequency 322 (LO) for converting the signal spectrum into another spectral range than the received signal serves for a decoupling of the received signal and transmit signal to prevent signal feedback loops. The multiplicative linking of a message with the bandwidth B_{TX} and key sequence with the bandwidth B_{Schüssel} generates a spreading of the signal bandwidth to (B_{TX}+B_{Schlüssel}). For decoupling the received signal and the transmit signal according to some embodiments the local oscillation frequency 322 is thus greater than the overall bandwidth (B_{TX}+B_{schlüssel}).

The additive linking of intermediary message 312 and second key sequence 308 is e.g. done via an active or passive combiner circuit. The signal transmission of the authentication message 316 with a frequency conversion in the frequency division multiplexing (FDM) improves signal detection by preventing or strongly suppressing crosstalk. Also a time division multiplexing (TDM) is possible. TDM requires a long delays line with high bandwidth including the complete signal frame length which may, however, also be realized digitally. Against the simple form of attack with amplifying relays both the implementations with TDM an also FDM are effective: the defined, fixed delay period may, for example, be stored in the authentication base device for TDM, so that an attacking relay which does not know the crypto sequence would have to look into the future to achieve a reduced runtime and execute a successful attack.

According to some embodiments, the signal runtimes within the authentication device are kept as short as possible. This makes stronger cryptographic methods of attacking more difficult, like e.g. “the Guessing Attack” and the “Early Bit Detection”. Thus, according to some embodiments, the processing steps are kept as short as possible. In particular, in some embodiments, cryptographic methods which process the data to be encrypted in blocks are omitted to avoid the connected latency. In the embodiments of the Figures methods are used wherein short sequences of data to be encrypted are directly combined with short sequences of the key sequences 306 and 308. In case of digital processing, this may mean, for example, that data to be encrypted are offset against the key sequences bitwise.

An alternative realization of the mobile authentication device as an analog relay may use a load modulation instead of a mixer for the multiplicative portion to switch between two (or more) phase layers. The encryption sequence may in this embodiment be utilized directly digitally and a digital-to-analog conversion of the same may be omitted.

In the embodiment shown in FIG. 4, the order of addition and multiplication is reversed, otherwise it corresponds to the embodiment shown in FIG. 3, which is why a detailed discussion of the embodiment is omitted. In other words, in FIG. 4 the first cryptographic method includes adding the first key sequence 306 to the initialization message 303, wherein the second cryptographic method includes multiplying the second key sequence 308 with the intermediary message 312.

In summary, embodiments enable to improve existing encryption by adding an additive term to a multiplicative modulation, as they are used, for example, in backscatter methods like passive RFID. In other words, the received code word is additionally added multiplicatively modulated to the own encrypted code word. Before the start of the actual method for generating an authentication message there may be a preceding communication with activation of the authentication device, in which further information may be exchanged encryptedly. Apart from that, already a basic synchronization may be executed in time and frequency.

In combined methods, the cryptographic part is in part put upon the TOF method via an encrypted communication channel and/or put before or behind the cryptographic part. Frequently, sequences are transmitted bitwise and transmitted back in XOR or NAND operations according to an encryption. In contrast to crypto location the cryptographic communication presents a wide field of application. It is technically usually based on one or several keys per communication partner. Here, symmetric encryption methods and non-symmetric encryption methods may be differentiated which use an identical key for encrypting and decrypting or a public key for encrypting and a private key for decrypting. Encryption methods are frequently attacked by methods of complete search (brute force), even if this problem is NP complete and thus a success may only be solved with exponential efforts (relating to the length of the key). When knowing a sequence of the non-encrypted source word it may also be possible to decrypt faster.

Using the proposed multi-stage (for example two-stage) hybrid encryption approach monitoring the approach by system technology may be excluded. Apart from that, the embodiments of the invention may also use shorter encryption methods maintaining the same security.

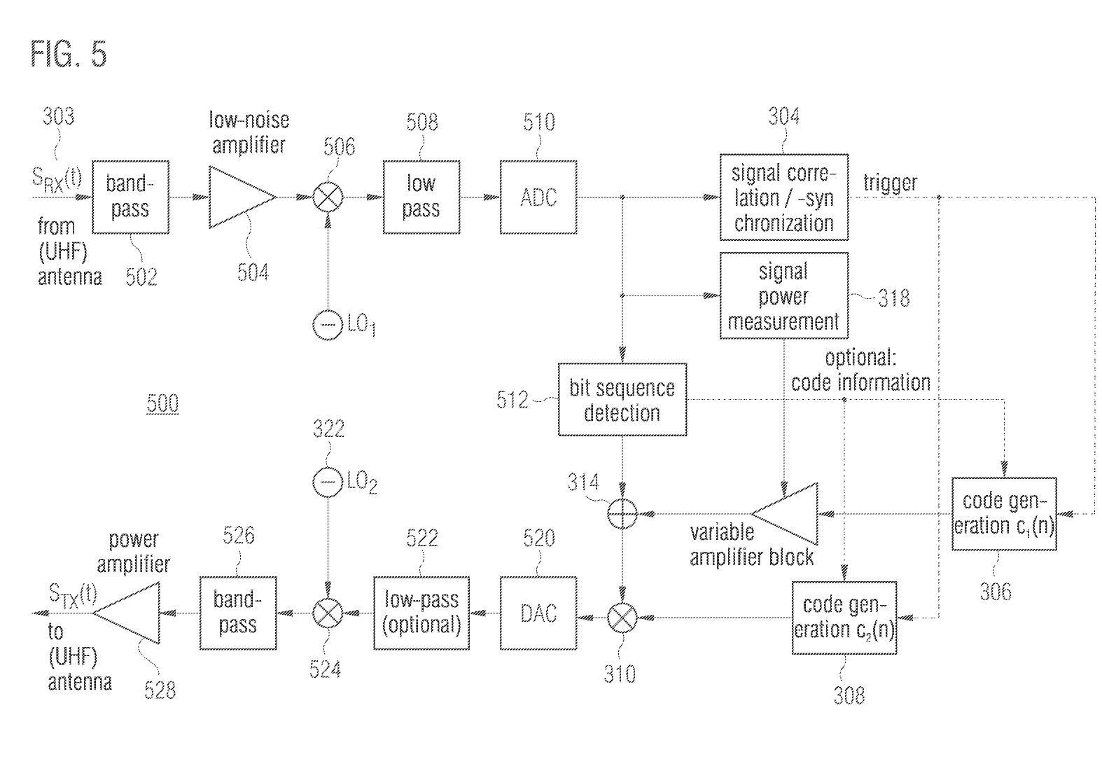

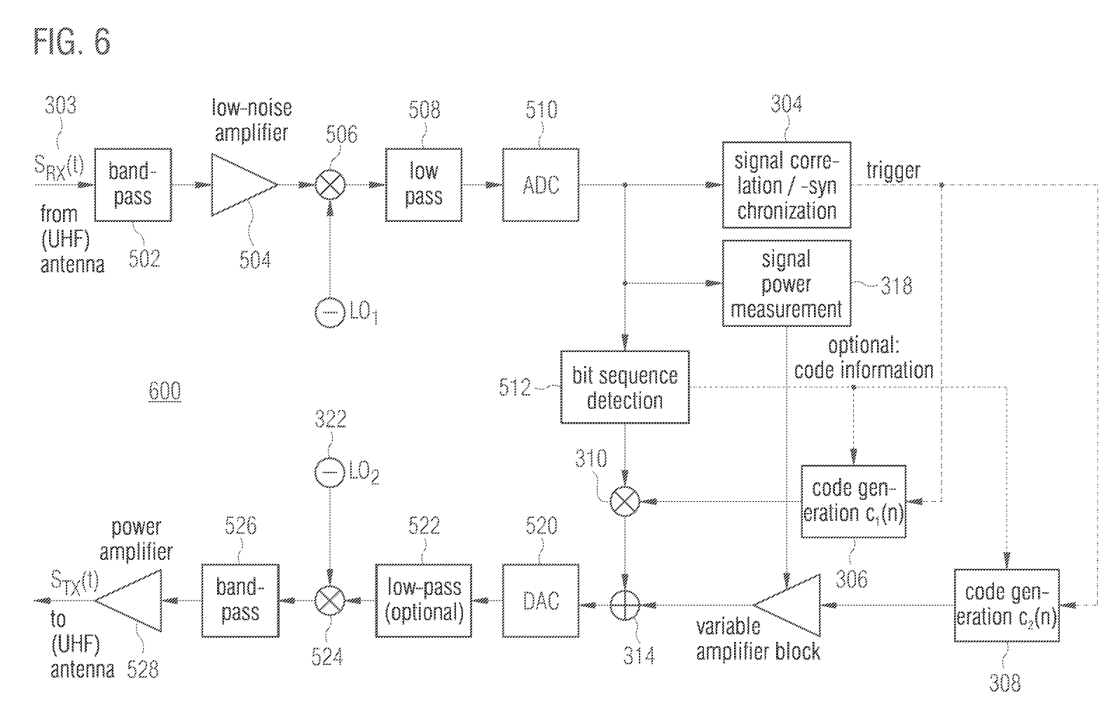

While FIGS. 3 and 4 show analogue implementations, exemplary digital embodiments are illustrated in FIG. 5 and FIG. 6. Apart from that, the functioning of the embodiment illustrated in FIG. 5 corresponds to that of FIG. 4 and the one of FIG. 6 to that of FIG. 3. Thus, functionally identical functional blocks are designated by the same reference numbers and in the following the differences due to digital processing are only mentioned briefly.

The received signal is at first sampled in an analog-digital converter 510 (ADC) after filtering by a band-pass filter 502 and amplification using an amplifier 504 (LNA), subsequent mixing into the baseband using a mixer 506 and band limitation of the baseband signal by means of a low pass 508. After that (after signal detection, synchronization and power estimation) the transmitted initialization message is detected in an analyzer 512 wherefrom a series of logic ones and zeroes results. The same is then additively and multiplicatively linked with the key sequences 306 and 308 which in turn are generated from the used keys. By the digital symbol and frame synchronization required for the determination of the initialization message 303, the synchronicity of the received sequence and the two key sequences 306 and 308 is guaranteed. In some embodiments, the bits of the authentication message are generated using the Galoisfeld-Logik GF(2). According to same, ⊕ is to be considered a logic exclusive “or” (XOR):

(0)₂⊕(0)₂=(0)₂, (0)₂⊕(1)₂=(1)₂, (1)₂⊕(0)₂=(1)₂ und (1)₂⊕(1)₂=(0)₂,

for higher dimensions GF(2ⁿ) e.g. GF(2⁵):

(10010)₂⊕(11100)₂=(01110)₂.

The ⊗ according to this logic is interpreted to be a logical “AND”:

(0)₂⊗(0)₂=(0)₂, (0)₂⊗(1)₂=(0)₂, (1)₂⊗(0)₂=(0)₂ und (1)₂⊗(1)₂=(1)₂,

and/or for higher dimensions GF(2ⁿ) e.g. GF(2⁵):

(10010)₂⊗(11100)₂=(10000)₂.

According to further embodiments a different allocation may be made, for example the logical “AND” may be replaced by the logical “OR” or a negation of one of them (NOR or NAND). In a digital implementation the signals remain in the same field and amplitude graduations may not occur due to this additive key sequence, whereby efficient transmitter structures may be used and this makes the separation of the two encryption words again more difficult.

Before transmitting same the digital authentication message is converted using a digital-to-analog converter 520 and after an optional filtering using a further low pass 522 it is mixed to the carrier frequency using a further mixer 524, if applicable filtered again with a further band pass 526 and amplified using a further amplifier 528 and then transmitted. Here again both FDM and also TDM is possible.

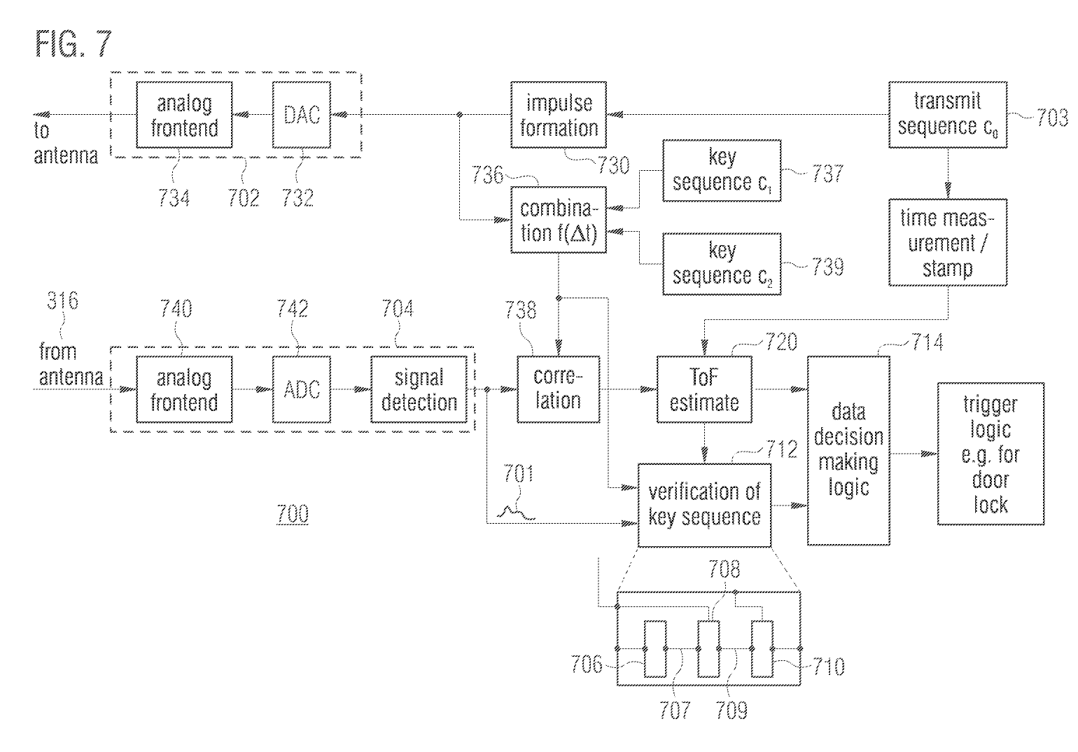

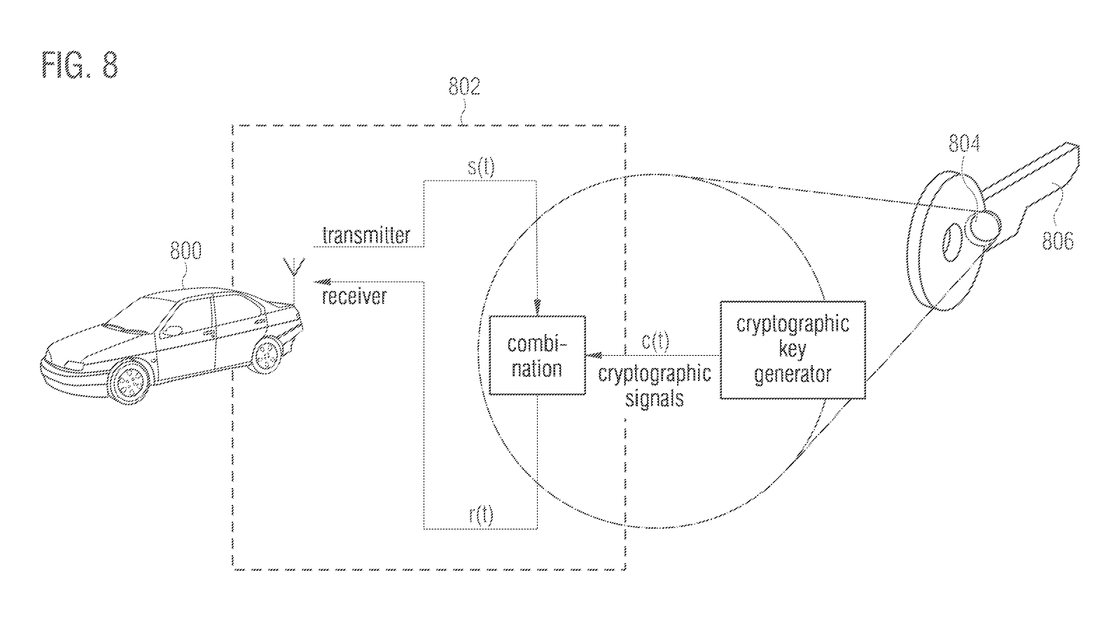

FIG. 7 shows a block diagram of an embodiment of an authentication base device 700. This includes a transmitter 702 configured to transmit an initialization message 703 and a receiver 704 configured to receive the authentication message 701. In the receiver 704 the signal coming from the receive antenna is at first filtered in the analog front-end 740, amplified and mixed into the baseband or a suitable intermediate frequency where it is sampled by an ADC 742.

Further the authentication base device 700 comprises a first decryption module 706 configured to decrypt the authentication message by a second cryptographic method to obtain a received intermediary message 707; and a second decryption module 708 configured to decrypt the received intermediary message 707 by a second cryptographic method to obtain a received initialization message 709. The first decryption module 706 and the second decryption module 708 are located within a cryptographic module 712 which further obtains the initialization message 703. The decision module 710 in the cryptographic module 712 is further configured to compare the received initialization message 709 and the initialization message 703 to determine whether the authentication message is considered as being authenticating. In the cryptographic module 712 the first key sequence 737, the second key sequence 739 and the initialization message 709 are used to validate the received initialization message and thus authenticate the transmitting authentication device.

The illustrated authentication base device 700 further supports an optional ToF verification. For this purpose, the authentication base device 700 further comprises a time measurement module 702 configured to determine a signal runtime between transmitting the initialization message 703 and receiving the authentication message 701. The determination of the signal runtime in the authentication base device 700 of FIG. 7 is mainly based on the execution of correlations between expected signal sequences and actually received signal sequences for the time measurement of a signal cycle. Determining the signal runtime allows to estimate the distance between authentication base device and authentication device and limit the zone of allowed access. As a second factor for the evaluation of a successful authentication the cryptographic module 712 guarantees using a verification logic that the correct authentication signal has been received and thus the authentication device is clearly identified.

The authentication base device 700 sends out the initialization message 703 (c_{vac}) at time t0 which may contain encrypted information and starts time measurement in the time measurement module 720. The initialization message is emitted by the transmit filter 730, digital-to-analog converter 732, analog transmit front-end 734 and transmit antenna. In a symmetric encryption the initialization message 703 is linked to the first key sequence 737 by the first cryptographic method and linked to the second key sequence 379 with the second cryptographic method in combination block 736 to generate a predicted authentication message with which the received authentication message is correlated in the correlator 738 to determine the receive time of the authentication signal. In case of non-symmetric encryption a correlation with other known signal sequences in the received signal may be used for that purpose, for example with a preamble, a midamble or a postamble.

In the digital part of the authentication base device 700, first of all the reception of a signal in the correlator 738 is detected (e.g. based on a preamble) before optionally the encrypted overall sequence of the predicted authentication message is correlated with the received signal to then calculate the arrival time T_{Ankunft} with higher accuracy from several correlation values. If the ranging message is divided into several sub-packets, the same may optionally be summarized for determining the runtime. Methods for this purpose are among others summarizing the correlation for determining the runtimes considering the respective transmit times of the initiating ranging messages, the determination of the runtimes and evaluating same according to the stochastic runtime distribution and/or characteristics based on the same. Examples for such characteristics are, for example, minimum, median, averages or percentiles which may be evaluated using the threshold value. In an alternative realization the correlation is replaced by a channel estimate—in the time or frequency range—from which then the first path is detected. Its time instant (which includes the processing time) is the arrival time T_{Ankunft}.

By deducting the time instant of sending out the signal to together with a known signal runtime T_{Laufzeit} within the authentication base device and possibly the processing time in the authentication device T_{Bearbeitung}, the signal runtime is acquired from which using the equation the distance d may be estimated:

$$d = \frac{{c}_{vac} ( {T}_{Amkunft} - {T}_{Sende} - {T}_{Laufzeit} - {T}_{Bearbeitung} )}{2} .$$

Here, c_{vac} is the vacuum speed of light and/or the propagation velocity of radio waves.

Parallel to runtime calculation, in the cryptographic module 712 the encrypted sequence is verified. An example realization executes this by accepting a maximum number of bit errors. That means, an authentication is only successful if the received initialization message and the initialization message deviate by less than an admissible number of bits. In case of a successful authentication, the received initialization message and the initialization message correspond to each other.

In some embodiments, for this purpose additionally the signal-to-noise ratio is determined to scale it to a minimum value and thus guarantee that the desired bit error threshold value is undershot. If the signal-to-noise ratio is too low the power in the authentication base device may be increased or the mobile authentication device may be given the command for increasing amplification via a communication connection. Alternatively it may be assumed that the authentication device is too far away from the authentication base device if the signal-to-noise ratio is not sufficient.

In the embodiment illustrated in FIG. 7 it is decided with an additional measurement of the signal runtime in a decision making logic 714 whether the authentication is assessed to be successful. According to some embodiments, this is only the case when the signal runtime is lower than a predetermined threshold and the received initialization message and the given original initialization message correspond to each other.

In case of a positive decision of a positive authentication with limited distance with a sufficient signal-to-noise ratio, for example a trigger signal may be generated which may open a door or start a car in an application in the field of automobiles.

Not illustrated, according to further embodiments the authentication base device may provide an adaptive gain control (AGC) in the analog receiver frontend to increase the range by a gradual power increase.

For the implementation of the embodiments the selected technology for transmitting the wireless signal is basically independent. In one realization, the transmission system may, for example, use a broadband single carrier modulation. A further implementation may, for example, use a multi-carrier modulation as a transmission method, wherein several (e.g. two) narrow-banded sub-carriers are distributed in the spectrum and modulated. In a further realization the transmission system may be an ultra-wideband system working with ultra-wideband signals.

FIG. 8 schematically illustrates an implementation of an embodiment of the invention for access control for an automobile 800. The automobile 800 comprises an authentication base device 802 according to one embodiment of the invention. One embodiment of an authentication device 804 is part of a key 806 for the automobile 800. Using this system an authentication of an authorized key and its user may be executed with high security against manipulation.

The features disclosed in the above description, the enclosed claims and the enclosed Figures may both individually and in any combination be of importance and implemented for realizing an embodiment in their various forms.

Although some aspects have been described in connection with an apparatus, it is clear that these aspects also illustrate a description of the corresponding method, where a block or a device of an apparatus is to be understood as a method step or a feature of a method step. Analogously, aspects described in the context of or as a method step also represent a description of a corresponding block or detail or feature of a corresponding apparatus.

Depending on certain implementation requirements, embodiments of the invention can be implemented in hardware or in software. The implementation can be performed using a digital storage medium, for example a floppy disk, a DVD, a Blue-Ray, a CD, a ROM, a PROM, an EPROM, an EEPROM or a FLASH memory, a hard disc or another magnetic or optical memory having electronically readable control signals stored thereon, which cooperate or are capable of cooperating with a programmable hardware component such that the respective method is performed.

A programmable hardware component may be formed by a processor, a Central Processing Unit (CPU), a Graphics Processing Unit (GPU), a computer, a computer system, an Application-Specific Integrated Circuit (ASIC), an Integrated Circuit (IC), a System on Chip (SOC), a programmable logics element or a Field Programmable Gate Array (FPGA) comprising a microprocessor.

Therefore, the digital storage medium may be machine or computer readable. Some embodiments include also a data carrier comprising electronically readable control signals which are capable of cooperating with a programmable computer system or a programmable hardware component such that one of the methods described herein is performed. One embodiment is thus a data carrier (or a digital storage medium or a computer readable medium) on which the program for executing of the methods described herein is stored.

Generally speaking, embodiments of the present invention may be implemented as a program, firmware, a computer program or a computer program product having a program code or as data, wherein the program code or the data is effective to execute one of the methods when the program is executed on a processor, or a programmable hardware component. The program code or the data may, for example, also be stored on a machine-readable carrier or data carrier. The program code or the data may among others be present as a source code, machine code or byte code or any other intermediate code.

A further embodiment is a data stream, a signal sequence or a sequence of signals which may represent the program for executing one of the methods described herein. The data stream, the signal sequence or the sequence of signals may for example be configured so as to be transferred via a data communication connection, for example via the internet or another network. Embodiments thus also are signal sequences representing data suitable for being transferred via a network or a data communication connection, the data representing the program.

The above described embodiments are merely an illustration of the principles of the present invention. It is understood that modifications and variations of the arrangements and the details described herein will be apparent to others skilled in the art. It is the intent, therefore, that this invention is limited only by the scope of the impending patent claims and not by the specific details presented by way of description and explanation of the embodiments herein.

1. A method of generating an authentication message, comprising:
receiving a transmitted initialization message;
encrypting the received initialization message by means of a first cryptographic method to obtain an intermediary message; and
encrypting the intermediary message by means of a second cryptographic method to obtain the authentication message.

2. The method according to claim 1, wherein the first cryptographic method uses a first key sequence and the second cryptographic method uses a second key sequence.

3. The method according to claim 2, wherein the first cryptographic method includes adding the first key sequence to the initialization message; and
the second cryptographic method includes multiplying the second key sequence with the intermediary message.

4. The method according to claim 2, wherein the first cryptographic method includes multiplying the first key sequence with the initialization message; and the second cryptographic method includes adding the second key sequence to the intermediary message.

5. The method according to claim 1, wherein the first key sequence and the second key sequence are used as an analog signal form.

6. The method according to claim 5, wherein an amplitude of the first key sequence and/or the second key sequenced deviates by less than 20% from an amplitude of the initialization message.

7. The method according to claim 5, wherein a bandwidth of the first key sequence) and/or the second key sequence deviates by less than 20% from a bandwidth of the initialization message.

8. The method according to claim 1, wherein the first key sequence and the second key sequence are used as a digital representation.

9. The method according to claim 1, wherein a first length of the first key sequence and/or a second length of the second key sequence deviates by less than 20% from a length of the initialization message.

10. A method of authenticating, comprising:
transmitting an initialization message;
receiving an authentication message;
decrypting the authentication message by means of a second cryptographic method to obtain a received intermediary message;
decrypting the received intermediary message by means of a first cryptographic method to obtain a received initialization message.
comparing the received initialization message and the transmitted initialization message to determine that the authentication message is regarded as being authenticating.

11. The method according to claim 10, wherein the authentication message is regarded as being authenticating when the received initialization message and the transmitted initialization message correspond to each other.

12. The method according to claim 11, wherein the received initialization message and the transmitted initialization message correspond to each other when both deviate from each other by less than an acceptable number of bits.

13. The method according to claim 10, further comprising: determining a signal runtime between transmitting the initialization message and receiving the authentication message.

14. The method according to claim 13, wherein the authentication message is only regarded as being authenticating when the signal runtime is less than a predetermined threshold.

15. An authentication device, comprising:
a receiver configured to receive a transmitted initialization message;
a first encryption module configured to encrypt the transmitted initialization message by means of a first cryptographic method to obtain an intermediary message;
a second encryption module, configured to encrypt the intermediary message by means of a second cryptographic method to obtain the authentication message; and
a transmitter configured to transmit the authentication message.

16. The authentication device of claim 15, further comprising a key for an automobile.

17. An authentication base device, comprising:
a transmitter configured to transmit an initialization message;
a receiver configured to receive an authentication message;
a first decryption module configured to decrypt the authentication message by means of a second cryptographic method to obtain a received intermediary message;
a second decryption modules, configured to decrypt the received intermediary message by means of a first cryptographic method to obtain a received initialization message; and
a decision module configured to compare the received initialization message and the transmitted initialization message to determine whether the authentication message is considered as being authenticating.

18. The authentication base device according to claim 17, further comprising: a time measurement module configured to determine a signal runtime between transmitting the initialization message and receiving the authentication message.

19. The authentication base device according to claim 18, wherein the decision module is configured to only regard the authentication message as being authenticating when the signal runtime is less than a predetermined threshold.

20. An automobile comprising the authentication base device of claim 17.
